(19) United States
(12) Patent Application Publication
(10) Pub. No.: US 2010/0156672 A1
(43) Pub. Date: Jun. 24, 2010

(54) SYSTEM AND METHOD FOR AUTO VALET PARKING

(75) Inventors: Jaejun YOO, Daejeon (KR); Byung Tae Jang, Daejeon (KR); Jeong Dan Choi, Daejeon (KR); Do Hyun Kim, Daejeon (KR); Kyung Bok Sung, Daejeon (KR); Jungsook Kim, Daejeon (KR); Jeong Ah Jang, Daejeon (KR); Kyeong Tae Kim, Chuncheon-si (KR); Jae Han Lim, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/639,385

(22) Filed: Dec. 16, 2009

(30) Foreign Application Priority Data
Dec. 19, 2008 (KR) 10-2008-0130645

(51) Int. Cl. B60Q 1/48

(52) U.S. Cl. 340/932.2; 340/436

(57) ABSTRACT

Provided are a system and a method for auto valet parking. In the system and method, a parking slot of a target vehicle among a plurality of slots formed in a parking place is determined based on situation information on the parking place and a movement path based on information on current location of the target vehicle and information on the parking slot is determined. The target vehicle is automatically parked in the determined parking slot by moving along the movement path.

### CROSS-REFERENCE TO RELATED APPLICATION

This application claims priority to and the benefit of Korean Patent Application No. 10-2008-0130645 filed in the Korean Intellectual Property Office on Dec. 19, 2008, the entire contents of which are incorporated herein by reference.

### BACKGROUND OF THE INVENTION

(a) Field of the Invention

The present invention a system and a method for auto valet parking.

(b) Description of the Related Art

Currently, a valet parking service for valet parking a vehicle in a hotel and a business building, etc., is provided in a form in which a person directly parks the vehicle in place of a vehicle driver in order to reduce inconvenience to the vehicle driver when parking the vehicle at a parking place.

Recently, a valet parking service using a robot has been provided. Thus, when the vehicle is parked at a specific location in a parking building, a mechanical apparatus directly moves the vehicle so that the vehicle may be parked at a specific location.

While such a valet parking service has evolved from an existing concept in which a person directly performs valet parking, it requires a large-scale mechanical facility for moving the vehicle and a large cost. Also, the valet parking service has a drawback in that it may not be applied to an existing parking building.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, the present invention has been made in an effort to provide a system and a method capable of providing an auto valet parking service by controlling a situation in a parking place and directly moving a vehicle using man-less vehicle control.

An exemplary embodiment of the present invention provides a system for providing an auto valet parking service of a vehicle in a parking place including a plurality of slots, the system including:

a plurality of vehicle guide sensors that are installed in the parking place and that guide driving of the vehicle; a plurality of parking situation sensing sensors that are installed in each of the plurality of slots and that sense whether vehicles are parked in the plurality of slots or not; and a service server that manages sensing information sensed from the plurality of vehicle guide sensors and the plurality of parking situation sensing sensors, determines a movement path of the vehicle and a parking slot of the vehicle of the plurality of slots based on the sensing information, and provides the movement path of the vehicle and the parking slot of the vehicle to the vehicle.

Another exemplary embodiment of the present invention provides a control system for controlling a vehicle receiving an auto valet parking service from a system for providing the auto valet parking service, the control system including:

a vehicle movement controller that controls movement of a vehicle based on guide information on the vehicle transmitted by the system for providing the auto valet parking service; an obstacle recognizer that recognizes an obstacle appearing during movement of the vehicle and generates obstacle recognition information; and a vehicle movement instructor that transfers vehicle parking instruction information to the vehicle movement controller to instruct the movement of the vehicle and transfers the obstacle recognition information to the system for providing the auto valet parking service.

Another exemplary embodiment of the present invention provides a method for providing an auto valet parking service of a vehicle in a system for providing the auto valet parking service, the method including:

receiving information on a target vehicle to use the service; determining a parking slot of the target vehicle of a plurality of slots formed in a parking place based on situation information on the parking place; determining a movement path based on information on current location of the target vehicle and information on the parking slot to transfer the movement path to the target vehicle; modifying the movement path to generate a modified movement path when an obstacle appears while guiding the target vehicle according to the movement path; and guiding the target vehicle through the modified movement path.

Another exemplary embodiment of the present invention provides a method for controlling a vehicle receiving an auto valet parking service through a system for providing the auto valet parking service, the method including:

requesting the service providing system to provide the service including information on a vehicle; when receiving guide information generated based on the information on the vehicle from the service providing system, initializing a vehicle movement control module and an obstacle recognition sensor; when receiving information informing recognition of the obstacle from the vehicle, transferring the obstacle recognition information to the service providing system; and receiving a modified guide information from the service providing system and controlling parking of the vehicle based on the modified guide information.

### BRIEF DESCRIPTION OF THE DRAWINGS

FIG. 1 is an exemplary diagram of a system for providing an auto valet parking service according to an exemplary embodiment of the present invention.

FIG. 2 is a configuration diagram of a vehicle controller according to an exemplary embodiment of the present invention.

FIG. 3 is a configuration diagram of a vehicle guide sensor according to an exemplary embodiment of the present invention.

FIG. 4 is a configuration diagram of a parking situation sensing sensor according to an exemplary embodiment of the present invention.

FIGS. 5A to 5D are configuration diagrams of a server according to an exemplary embodiment of the present invention.

FIG. 6 is a configuration diagram of a terminal according to an exemplary embodiment of the present invention.

FIGS. 7A and 7B are flowcharts showing an auto parking method according to an exemplary embodiment of the present invention.

FIG. 8 is a flowchart showing an auto vehicle-exiting method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

In the specification, a terminal may be referred to as a mobile station (MS), a mobile terminal (MT), a subscriber station (SS), a portable subscriber station (PSS), user equipment (UE), an access terminal (AT), etc., and may include all or some functions of the mobile terminal, the subscriber station, the portable subscriber station, the user equipment, etc.

Hereinafter, a system and a method for providing an auto valet parking service according to an exemplary embodiment of the present invention will be described in detail with reference to the accompanying drawings.

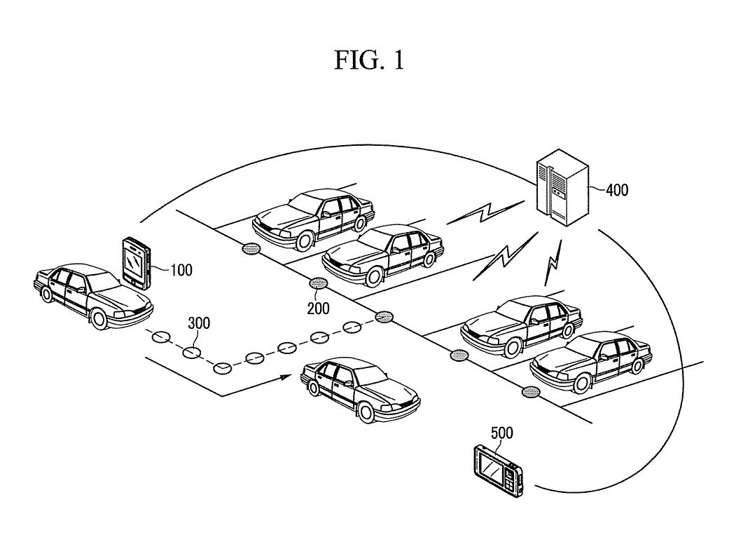

FIG. 1 is an exemplary diagram of a system for providing an auto valet parking service according to an exemplary embodiment of the present invention.

As shown in FIG. 1, in the exemplary embodiment of the present invention, it is possible to provide information on a final parking location in a parking place to a terminal of a driver without a person directly driving the vehicle. Also, the system has a structure such that it receives guide information from a sensor network, etc., and moves the vehicle using man-less vehicle control.

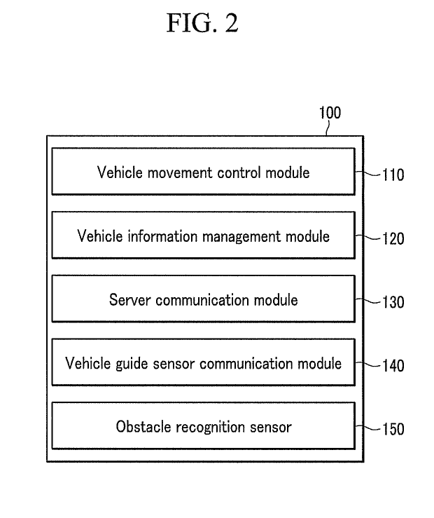

To this end, the system according to the exemplary embodiment of the present invention includes a vehicle controller 100 that provides information on a parking target vehicle to use the auto valet parking service, a vehicle guide sensor 300 that guides movement of the vehicle within the parking place, a parking situation sensing sensor 200 that understands and manages parking situations of vehicles within the parking place, and an auto valet parking service server (hereinafter referred to as ‘service server’) 400 that senses a dynamic situation within the parking place and determines a movement path of the vehicle, thereby providing auto valet parking service information to a remote user terminal (hereinafter referred to as ‘user terminal’) 500 for providing an auto valet parking service result, etc., to a remote user. A specific configuration of components stated in FIG. 1 will be described with reference to FIGS. 2 to 6.

FIG. 2 is a configuration diagram of a vehicle controller 100 according to an exemplary embodiment of the present invention.

As shown in FIG. 2, a target vehicle according to an exemplary embodiment of the present invention includes the vehicle controller 100, wherein the vehicle controller 100 includes a vehicle movement control module 110, a vehicle information management module 120, a service server communication module 130, a vehicle guide sensor communication module 140, and an obstacle recognition sensor 150.

In the exemplary embodiment of the present invention, although it has been shown that the vehicle information management module 120, the service server communication module 130, and the vehicle guide sensor communication module 140 are included in the vehicle controller 100, they may be included in an information providing device such as a terminal and may be mounted in the vehicle or mounted in the vehicle in a form such as a vehicle movement instructor (not shown) other than the terminal.

The vehicle movement control module 110 controls the movement (e.g., stop, movement, leftward/rightward movement, acceleration, deceleration, etc.) of the parking target vehicle receiving information in a predefined form from the service server 400. At this time, if receiving instruction information on auto parking or auto vehicle-exiting from the service server 400, the vehicle movement control module 110 controls the movement of the target vehicle. Herein, the information receiving from the service server 400 includes initial movement path information, etc., related to parking.

The vehicle information management module 120 manages a variety of information on the vehicle that is necessary for the auto valet parking service. Herein, the information on the vehicle includes information on a unique ID granted to the vehicle, information on a vehicle type, information on current location of the vehicle, etc.

The service server communication module 130 performs communication with the service server 400 in order to start or end the auto valet parking service. That is, when a driver requests starting the auto valet parking service, the service server communication module 130 transmits the requested information to the service server 400 so that the service is provided. Also, when the auto valet parking service ends, the service server communication module 130 receives information informing that the service has ended from the service server 40 so that start-up of the vehicle may stop.

The vehicle guide sensor communication module 140 receives vehicle guide information from the vehicle guide sensor 300, and may allow the vehicle to be parked or exited based on the vehicle guide information. Herein, the vehicle guide information includes information of the vehicle for parking, information on movement direction of the vehicle, information on location of the vehicle guide sensor, and information on location of destination (information on a parking slot or information on vehicle-exiting location), etc.

The obstacle recognition sensor 150 recognizes an obstacle appearing during man-less movement of the vehicle, and controls so that the vehicle may be protected from the obstacle. Information on the obstacle recognized by the obstacle recognition sensor 150 (information on location of the recognized obstacle, etc.) are transferred to an alert information generator 340 of the vehicle guide sensor 300 and the service server 400.

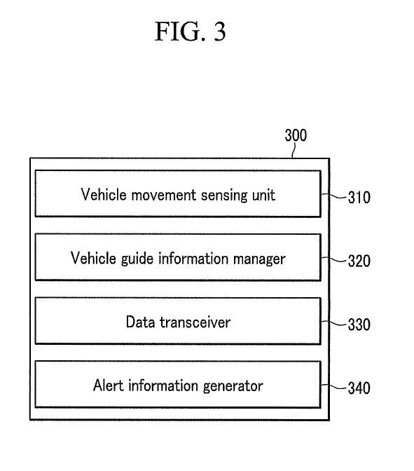

Next, the vehicle guide sensor 300 that guides the movement of the vehicle while the auto valet parking service is provided will be described with reference to FIG. 3.

FIG. 3 is a configuration diagram of a vehicle guide sensor according to an exemplary embodiment of the present invention

As shown in FIG. 3, the vehicle guide sensor 300 includes a vehicle movement sensing unit 310, a vehicle guide information manager 320, a data transceiver 330, and the alert information generator 340.

The vehicle movement sensing unit 310 senses whether the vehicle moves or not, and understands movement direction of the vehicle. Since a method for sensing whether the vehicle moves or not has already been known, the detailed description thereof will be omitted in an exemplary embodiment of the present invention.

The vehicle guide information manager 320 manages a variety of guide information on movement of the vehicle. Herein, the guide information on the movement of the vehicle includes information on the movement direction of the vehicle, information of the target vehicle, information on location of the vehicle guide sensor, information on location of destination, etc. At this time, the information on the movement direction of the vehicle is provided from the vehicle movement sensing unit 310, and the information on the target vehicle is provided from information stored in the vehicle information management module 120 through the vehicle guide sensor communication module 140.

The data transceiver 330 wirelessly transceives data with the vehicle guide sensor communication module 140 of the target vehicle, a data transceiver 230 of the parking situation sensing sensor 200, or a communicator 410 of the service server 400.

When the alert information generator 340 receives information on the obstacle from the obstacle recognition sensor 150 or the vehicle movement sensing unit 310 during progress of the vehicle guide, it determines whether the information on the obstacle comes from the obstacle recognition sensor 150 or from the vehicle movement sensing unit 310. If the obstacle sensing information is information transmitted from the obstacle recognition sensor 150, the alert information generator 340 transfers the corresponding obstacle sensing information to the service server 400 to request modification of the movement path of the vehicle. Herein, the alert information includes information on current location of the vehicle, the obstacle sensing information, etc.

Meanwhile, if the alert information generator 340 receives the obstacle sensing information from the vehicle movement sensing unit 310, it transmits a control signal to the vehicle movement control module 110 in order to perform control such as deceleration or movement stop of the vehicle. If it is determined that the obstacle is not solved through the movement stop or the deceleration, the alert information generator 340 transfers the obstacle sensing information to the service server 400 to request a new movement path.

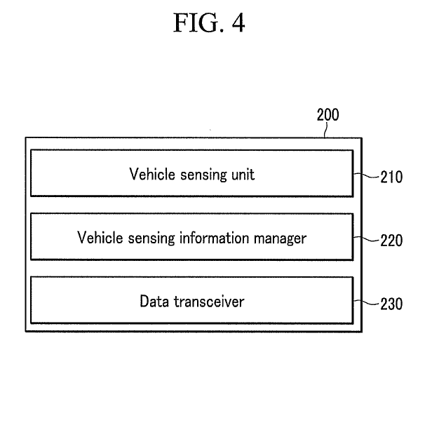

Next, the parking situation sensing sensor 200 that understands a state (e.g., whether the vehicle is parked or not) of each of parking slots within the parking place will be described with reference to FIG. 4.

FIG. 4 is a configuration diagram of a parking situation sensing sensor according to an exemplary embodiment of the present invention.

As shown in FIG. 4, the parking situation sensing sensor 200 includes a vehicle sensing unit 210, a vehicle sensing information manager 220, and the data transceiver 230.

The vehicle sensing unit 210 senses whether vehicles are parked in each slot or not, and transfers the sensed information to the vehicle sensing information manager 220. At this time, the vehicle sensing unit 210 senses whether the vehicles are parked or not through communication with the obstacle recognition sensor 150 installed in the vehicle or through recognition of a front end of the vehicle. Since a method for sensing the vehicle has already been known, the detailed description thereof will be omitted in an exemplary embodiment of the present invention.

The vehicle sensing information manager 220 receives, stores, and manages vehicle sensing information sensed in the vehicle sensing unit 210. And, if the service server 400 requests the vehicle sensing information manager 220 to provide the vehicle sensing information, the vehicle sensing information manager 220 transfers the vehicle sensing information to the service server 400.

The data transceiver 230 wirelessly transfers the vehicle sensing information managed in the vehicle sensing information manager 220 to the service server 400 using a sensor network communication method.

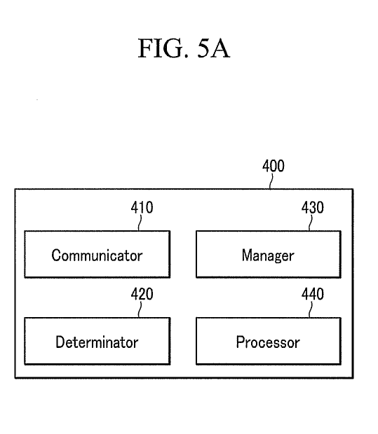

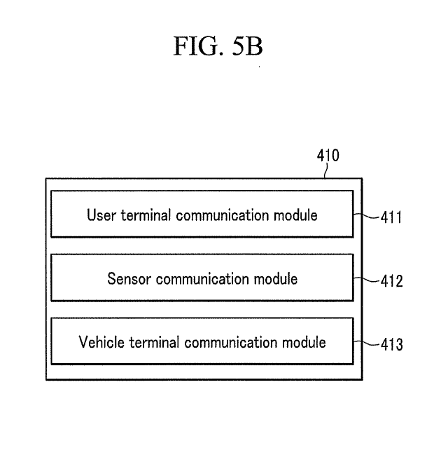

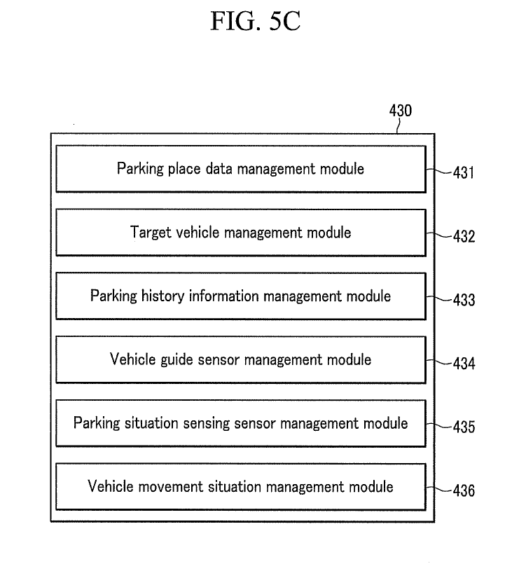

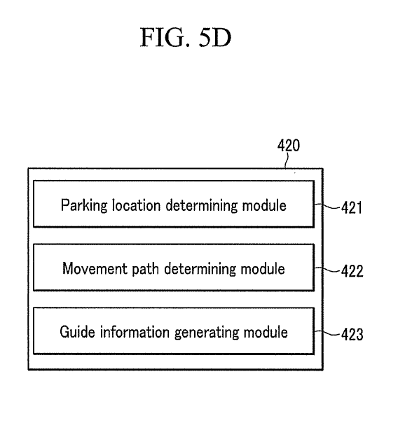

Next, the service server 400 that generally controls the auto valet parking service and manages other components of the system will be described with reference to FIG. 5.

FIGS. 5A to 5D are configuration diagrams of a service server according to an exemplary embodiment of the present invention.

As shown in FIG. 5A, the service server 400 includes the communicator 410, a manager 430, a determiner 420, and a processor 440.

First, the communicator 410 communicating with other components of the system includes a user terminal communication module 411, a sensor communication module 412, and a vehicle terminal communication module 413, as shown in FIG. 5B.

The user terminal communication module 411 communicates with a service server communicator 520 of a user terminal 500 described below in order to provide information to a user, etc., away from an auto valet parking service region.

The sensor communication module 412 communicates with the data transceiver 230 of the parking situation sensing sensor 200 and the data transceiver 330 of the vehicle guide sensor 300.

The vehicle terminal communication module 413 communicates with the service server communication module 130 within the target vehicle to use the auto valet parking service, thereby transceiving information.

The manager 430 of the service server 400 includes a parking place data management module 431, a target vehicle management module 432, a parking history information management module 433, a vehicle guide sensor management module 434, a parking situation sensing sensor management module 435, and a vehicle movement situation management module 436, as shown in FIG. 5C.

The parking place data management module 431 manages overall information on the parking place, such as information on a map of the parking place, information on a movable path within the parking place, the number of parking slots, etc.

The target vehicle management module 432 manages information on the target vehicle to use the auto valet parking service, with relation to service provision and data processing related to the auto valet parking service. Herein, the information on the vehicle includes information on an ID granted to the vehicle, information on a vehicle type, information on location of the vehicle, etc., and is received from the vehicle information management module 120 of the target vehicle.

The parking history information management module 433 stores and manages past parking situation data for the vehicle currently using the auto valet parking service as well as parking history information on all vehicles previously using the service, in order to improve quality of service.

The vehicle guide sensor management module 434 monitors and manages a current situation of the sensor network, etc., in order to guide the vehicle to use the auto valet parking service up to the slot The parking situation sensing sensor management module 435 monitors and manages a current operation situation of the sensor sensing parking situations of each slot.

The vehicle movement situation management module 436 manages information on movement situation of the target vehicle. Herein, the information on the movement situation includes information on current location of the vehicle and information on a next movement direction of the vehicle, the information being received from the vehicle guide sensor 300.

The determiner 420 of the service server 400 includes a movement path determining module 422, a parking location determining module 421, and a guide information generating module 423, as shown in FIG. 5D.

The parking location determining module 421 determines an optimal parking location of the target vehicle to use the auto valet parking service. At this time, the parking location determining module 421 uses information on the current location of the vehicle in order to determine the optimal location, wherein the information on the current location of the vehicle is received from the vehicle movement control module 110.

When the optimal parking location is determined by the parking location determining module 421, the movement path determining module 422 dynamically determines a movement path from the current location of the vehicle to a corresponding slot and transfers information on the determined movement path to the vehicle guide sensor 300, thereby allowing the vehicle to be able to be guided to the slot. Also, when the movement path determining module 422 is instructed to modify the movement path from the processor 440 because of appearance of the obstacle during the movement of the vehicle, it modifies the current movement path and transfers the modified movement path to the vehicle guide sensor 300.

The guide information generating module 423 generates guide information including information on the parking slot and the movement path determined in the parking location determining module 421 and the movement path determining module 422.

When the processor 440 receives obstacle sensing information informing that the obstacle was found during the movement of the vehicle from the vehicle guide sensor 300 or the obstacle recognition sensor 150, it understands urgency degree information included in the obstacle sensing information, thereby making it possible to urgently process the state of the vehicle. That is, the processor 440 determines whether cause for the obstacle is solved or not by checking a situation per a preset period, and performs determiner such as stand-by or movement path reset of the vehicle, etc., accordingly. If the processor 440 determines the stand-by of the vehicle, it transfers this determination to the vehicle movement control module 110 through the service server communication module 120 to control so that the vehicle does not move. Meanwhile, if the processor 440 determines the movement path reset of the vehicle, it instructs the movement path determining module 422 to reset the movement path.

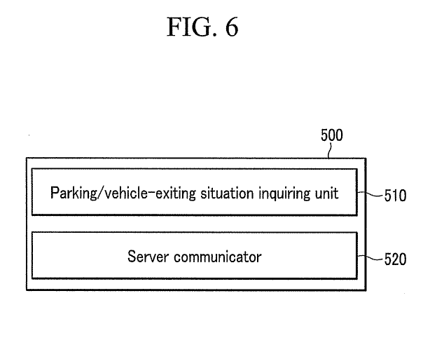

Next, the user terminal 500 possessed by a user positioned a long distance away and allowing the user to easily understand the situation of the auto valet parking service will be described with reference to FIG. 6

FIG. 6 is a configuration diagram of a user terminal according to an exemplary embodiment of the present invention.

As shown in FIG. 6, the user terminal 500 includes a parking/vehicle-exiting situation inquiring unit 510 to be able to inquire a current service situation, and the service server communicator 520 supporting communication with the service server 400 to be able to remotely instruct the provision of the auto valet parking service.

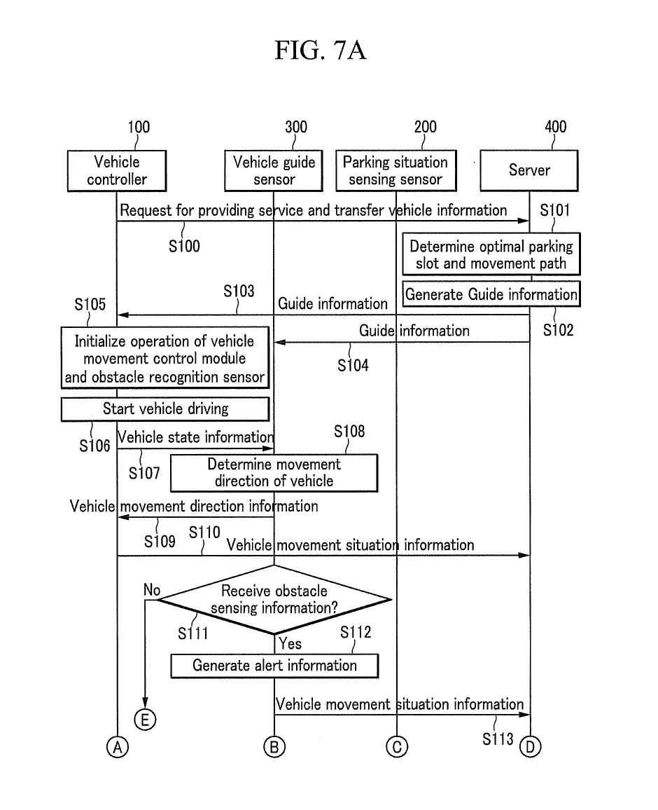

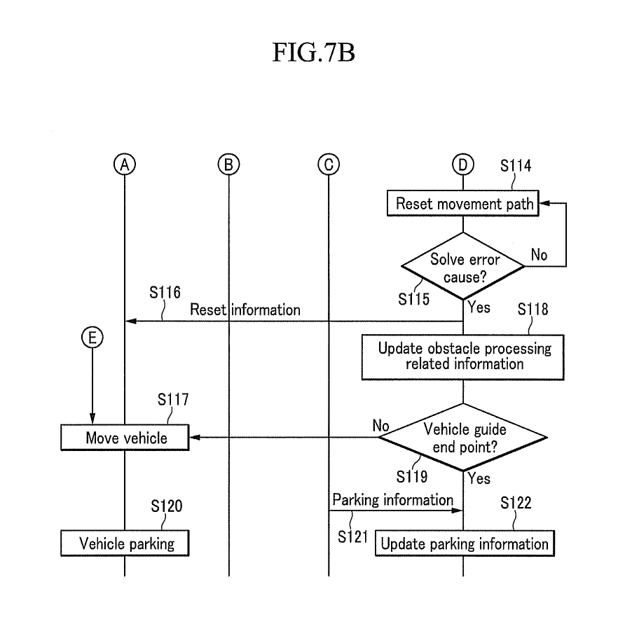

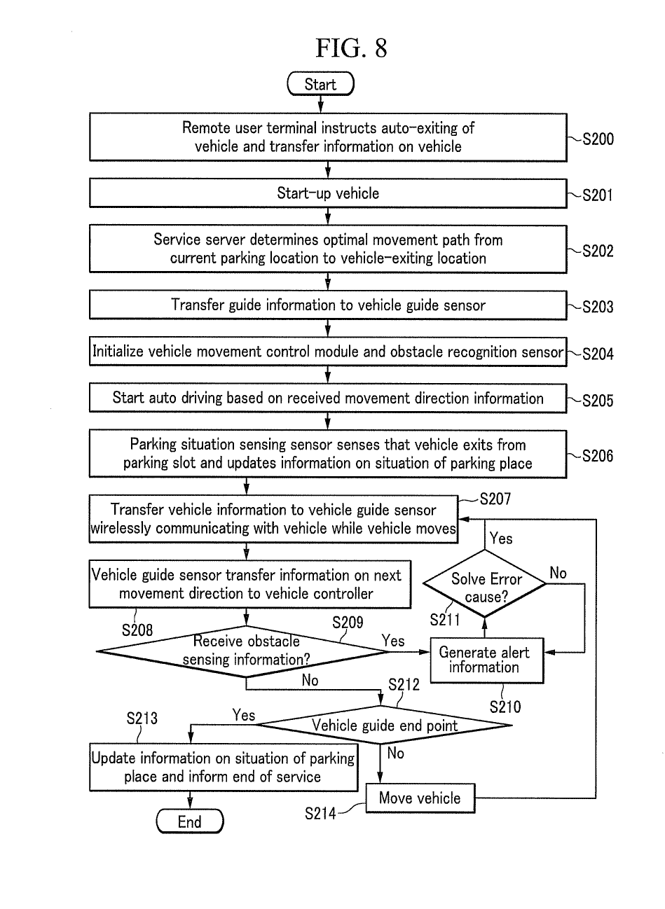

An auto parking method and an auto vehicle-exiting method using a sensor network infrastructure and a man-less vehicle control among services supported by the system constituted by the above-mentioned components will be described with reference to FIGS. 7A, 7B, and 8.

FIGS. 7A and 7B are flowcharts showing an auto parking method according to an exemplary embodiment of the present invention.

As shown FIGS. 7A and 7B, when a driver requests starting of the auto parking service after stopping the vehicle at a specific location, the vehicle controller 100 receives service start instruction information through the service server communication module 130. Then, the service server communication module 130 transfers the service start instruction information to the service server 400 to request provision of the service. At the same time, the service server communication module 130 transfers information on the vehicle stored in the vehicle information management module 120 to the service server 400 (S100). Herein, the information on the vehicle may include, but is not necessarily limited to, information on an ID uniquely granted per vehicle, information on a vehicle type, information on the current location of the vehicle, etc.

When the vehicle terminal communication module 413 of the service server 400 receives the information on the vehicle and the service provision requesting information from the service server communication module 130, it collects information on a current state of the parking place stored in the parking place data management module 431 to transfer the information to the parking location determining module 421. The parking location determining module 421 determines location of the slot at which the target vehicle 100 may be parked, and may refer to information on past parking history of the target vehicle managed in the parking history information management module 433 in the process of determining the location of the vehicle. That is, by referring to the past parking history in order to minimize the movement of the vehicle and park the vehicle as rapidly as possible, the location of the slot may be determined. For example, when it is determined that some vehicles, etc., will more rapidly exit than other vehicles among overall vehicles, they will be parked at a front portion of the parking place entrance.

When the parking location determining module 421 determines the parking slot at which the target vehicle will be parked, the movement path determining module 422 determines an optimal movement path from the current location of the vehicle to a target slot (S101). When determining the movement path, information such as movement situations of other vehicles currently present within the parking place, etc., is referred to, wherein the information may be received through the target vehicle management module 432 and the vehicle movement situation management module 436.

The guide information generating module 423 generates guide information including the parking slot and the movement path determined by the parking location determining module 421 and the movement path determining module 422 (S102). At this time, information on the movement direction of the vehicle, information on the target vehicle, information on the location of the vehicle guide sensor, etc., are also included in the guide information. The guide information including information on the parking slot and information on the movement path up to the corresponding slot each determined by the parking location determining module 421 and the movement path determining module 422 is transferred to the vehicle terminal 120 and the vehicle guide sensor 300 through the vehicle terminal communication module 413 and the sensor communication module 412 (S103 and S104).

When the vehicle controller 100 receives the guide information from the guide information generating module 423, it initializes operations of the vehicle movement control module 110 and the obstacle recognition sensor 150 in order to start auto driving of the vehicle (S105). At the same time, the vehicle guide sensor 300 prepares information to be transferred from each sensor node to the vehicle controller 100. At this time, information on the direction of the vehicle, etc., is included in the information to be transferred.

The target vehicle receives initial vehicle movement information through the vehicle guide sensor communication module 140 of the vehicle controller 100 and starts auto driving (S106).

When the vehicle controller 100 transfers information on the current state of the vehicle to the vehicle guide sensor 300 through the vehicle guide sensor communication module 140 while the target vehicle moves (S107), the sensor node in the vehicle guide sensor 300 determines a next movement direction of the vehicle with reference to the information received from the vehicle controller 100 and the information received from the service server 400 (S108). The determined information is transferred to the vehicle controller 100 through the vehicle guide sensor communication module 140 (S109). Herein, the information on the current state of the vehicle includes information on a movement situation, a control situation of the vehicle, etc.

The determination in S108 step is made with reference to the vehicle movement sensing unit 310 sensing the movement of the vehicle and the vehicle guide information manager 320. The information on the movement situation of the vehicle is transferred to the service server 400 through the data transceiver 330 of the vehicle guide sensor 300 (S110). Also, the information is again transferred to the user terminal 500 through the user terminal communication module 411. The user may confirm a current service progress situation through the parking/vehicle-exiting situation inquiring unit 510 in the user terminal.

In the case where a progress situation of the auto parking is reported to the driver riding in the target vehicle, the parking progress information transferred to the vehicle controller 100 may be output. During the progress of such an auto parking service, the alert information generator 340 of the vehicle guide sensor 300 determines whether the obstacle sensing information has been received or not (S111). If it is determined that there is no the obstacle sensing information, the vehicle moves according to a procedure of step S117 described below, and is parked according to procedure of step S120.

At this time, the obstacle sensing information is information on when the obstacle recognition sensor 150 in the target vehicle senses the obstacle such as a pedestrian and transfers the obstacle information to the alert information generator 340, or information generated when the vehicle movement sensing unit 310 of the vehicle guide sensor 300 senses the obstacle such as another vehicle present in the middle of the movement path, etc. When the alert information generator 340 receives the obstacle sensing information, it generates alert information including the obstacle sensing information (S112).

The alert information may be transferred to the alert information generator 340 of the vehicle guide sensor 300 or the service server 400 according to the location from which the obstacle sensing information is transmitted. Herein, the urgency degree means urgency degree with regard to whether the obstacle appears due to adjacency of the target vehicle or an overall situation of the parking place.

For the alert information generator 340 to solve error causes for the obstacle according to the urgency degree, the alert information generator 340 transmits the control signal to the vehicle movement control module 110 of the vehicle controller 100 in order to decelerate or stop the target vehicle, thereby changing the movement of the vehicle. However, when the alert information is transferred to the service server 400 (S113), the processor 440 determines whether predetermined movement path information of the vehicle should be modified or if the auto driving of the vehicle should be stopped. If it is determined that the movement path should be modified, the processor 440 allows the movement path determining module 422 to reset the movement path (S114). However, if it is determined that the driving of the vehicle should be stopped, the processor 440 controls the vehicle movement control module 110 of the vehicle controller 100 to stop the driving of the vehicle.

The vehicle guide information that is changed with relation to the processing for the obstacle is transferred to and stored in the service server 400. The vehicle guide sensor 300 and the service server 400 determine whether the error cause for the found obstacle has been solved or not, per preset period (S115). If the processor 440 determines that the cause for the obstacle has been solved, the target vehicle and the vehicle guide sensor 300 transfer the reset movement path to the vehicle controller 100 in order to again start the vehicle guide service according to current location of the target vehicle (S116). However, if the processor 440 determines that the cause for the obstacle has not been solved, steps such as stop of the driving of the vehicle through the vehicle control or re-modification of the movement path of the vehicle, etc., are repeatedly performed.

After performing the processing for the obstacle, the target vehicle uses the vehicle movement information received from the vehicle guide sensor 300 through the sensor communication module 412 to move the vehicle by direction and distance included in the vehicle movement information (S117). And, the service server 400 updates information related to the processing for the obstacle (S118).

It is determined whether the target vehicle arrives at a vehicle guide end point for the auto parking, i.e., a slot location at which it will be parked, by repeatedly performing the above-mentioned process (S119). If the target vehicle arrives at the vehicle guide end point, it performs a parking assistance function through the vehicle movement control module 110 to be parked at the corresponding slot (S120). And, parking information generated through the parking is sensed by the vehicle sensing unit 210 of the parking situation sensing sensor 200 to be transferred to the service server 400 through the data transceiver 230 (S121).

The service server 400 receives the parking information from the parking situation sensing sensor 200 through the sensor communication module 412, and updates parking information generated because a new vehicle is parked at the slot (S122). When the auto parking of the vehicle is completed, completion information is transferred to the vehicle controller 110 and the user terminal 500 to inform parking completion of the user, and the vehicle movement control module 110 ends the start-up of the vehicle.

Next, a method for automatically exiting the parked vehicle will be described with reference to FIG. 8.

FIG. 8 is a flowchart showing an auto vehicle-exiting method according to an exemplary embodiment of the present invention.

The auto vehicle-exiting method is performed in reverse order to the auto parking method described in FIGS. 7A and 7B. As shown in FIG. 8, the remote user requests the service server 400 for automatically exiting the target vehicle parked in the parking place, through the service server communicator 520 of the user terminal 500 (S200). Then, the service server 400 operates the vehicle through the vehicle controller 100 and the vehicle movement control module 110 of the exiting target vehicle (S201). At this time, the service server 400 receives the information on the vehicle from the target vehicle management module 432.

Next, the parking movement path determining module 422 of the service server 400 determines an optimal movement path from current parking location of the vehicle to specific vehicle-exiting location (S202). Such a path determination is made with reference to information on a parking place, information on a vehicle, and information on movement situations of the vehicles within the parking place stored in the parking data management module 431, the target vehicle management module 432, and the vehicle movement situation management module 436.

A guide information generating module 423 generates guide information including information on the movement path determined in S202 step and transfers the guide information to the vehicle controller 100 and the vehicle guide sensor 300 through the vehicle terminal communication module 413 and the sensor communication module 412 (S203). The vehicle controller 100 initializes the operations of the vehicle movement control module 110 and the obstacle recognition sensor 150 in order to start auto driving of the vehicle based on the received information (S204). At the same time, the vehicle guide sensor 300 uses the received information to prepare information to be transferred from each sensor node in the sensor to the corresponding vehicles.

The target vehicle receives initial vehicle movement information through the vehicle guide sensor communication module 140 of the vehicle controller 100 and starts the auto driving (S205). When the auto driving of the vehicle starts so that the vehicle exits from the parking slot at which it was parked, the parking situation sensing sensor 200 updates internal parking situation data through the vehicle sensing unit 210 and transfers the updated data to the service server 400 through the vehicle sensing information manager 230.

The service server 400 uses the received information from the vehicle sensing information management 230 to update the information on a situation of the parking place managed by the service server 400 (S206). Such an update process is performed in the parking place data management module 431, the target vehicle management module 432, the parking history information management module 433, the vehicle movement situation management module 436, etc.

When the vehicle controller 100 transfers information on a current state of the vehicle (e.g., information on a movement situation of the vehicle, information on a control situation of the vehicle, etc.) to the vehicle guide sensor 300 through the vehicle guide sensor communication module 140 while the target vehicle moves (S207), the sensor node in the vehicle guide sensor 300 determines a next movement direction of the vehicle with reference to the information received from the vehicle controller 100 and the information received from the service server 400. The determined information is transferred to the vehicle guide sensor 300 and the target vehicle through the data transceiver 330 and the vehicle guide sensor communication module 140 (S208). At this time, the determination of the movement direction of the vehicle is made with reference to the vehicle movement sensing unit 310 sensing the movement of the vehicle and the vehicle guide information manager 320.

The information on the movement situation generated during the movement of the vehicle is also transferred to the service server 400 through the data transceiver 330 of the vehicle guide sensor 300. The information is again transferred to the user terminal 500 through the user terminal communication module 411 so that the user may confirm the information through the parking/vehicle-exiting situation inquiring unit 510. In the case of a progress situation of the auto vehicle-exiting being reported to the driver riding in the target vehicle, the vehicle-exiting progress information transferred to the vehicle controller 100 may be output.

During the progress of such an auto vehicle-exiting service, the obstacle recognition sensor 150 senses whether there is an obstacle such as a pedestrian or not. If the obstacle recognition sensor 150 senses the obstacle or the vehicle movement sensing unit 310 in the vehicle guide sensor 300 senses that another vehicle exists in the middle of the movement path (S209), the alert information generator 340 generates alert information including obstacle sensing information (S210).

In this case, the alert information generator 340 in the vehicle guide sensor 300 directly changes the movement of the vehicle according to an urgency degree included in the alert information. The alert information generator 340 transfers the obstacle sensing information to the service server 400 so that the processor 440 may instruct to modify information on a predetermined auto driving path of the vehicle or stop the auto driving of the vehicle. Herein, the alert information processed by the alert information generator 340 is dynamically generated due to adjacency of the target vehicle. The alert information processed by the processor 440 is information related to the overall situation of the parking place.

The vehicle guide information that is changed with relation to the processing for the obstacle is transferred to the service server 400, thereby updating information stored in each internal module. After the obstacle appears, the vehicle guide sensor 300 and the processor 440 of the service server 400 determine whether the error cause for the obstacle has been solved by periodically checking the situation or not (S211). If it is determined that the error cause for the obstacle has been solved, the target vehicle and the vehicle guide sensor 300 again starts the vehicle guide service according to the current location of the target vehicle. However, if it is determined that the error cause for the obstacle has not been solved, steps such as stopping of the driving of the vehicle through the vehicle control or re-modification of the movement path of the vehicle, etc., are repeatedly performed.

After performing the processing for the obstacle, the target vehicle 100 uses the vehicle movement information received from the vehicle guide sensor 300 to move the vehicle by direction and distance provided by the vehicle movement control module 110.

The service server 400 determines whether the target vehicle has arrived at a vehicle guide end point for the auto vehicle-exiting or not by repeatedly performing the above-mentioned process (S212). If it is determined that the vehicle has not arrived at the vehicle guide end point, the vehicle movement control module 110 continues to move the vehicle to the vehicle guide end point (S214).

However, if it is determined that the vehicle has arrived at the vehicle guide end point, information that should be updated due to the end of the auto vehicle guide is newly updated. The update work is performed in the parking place data management module 431, the target vehicle management module 432, the vehicle movement situation management module 436, the parking history information management module 433, etc. When the auto exiting of the vehicle is successfully completed, completion information is transferred to the vehicle controller 100 and the user terminal 500 to be provided to the user (S213).

With the exemplary embodiments of the present invention, since a vehicle may be automatically parked based on a sensor network and a man-less vehicle control, it is possible to provide an auto valet parking service without a person directly driving the vehicle.

Therefore, since a number of vehicles simultaneously use the valet parking service, efficiency of the service may be enhanced. In addition, human damage or a risk of inter-vehicle collision or collision with objects other than a vehicle may be reduced.

The above-mentioned exemplary embodiments of the present invention are not embodied only by a method and apparatus. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for providing an auto valet parking service of a vehicle in a parking place including a plurality of slots, comprising:
a plurality of vehicle guide sensors that are installed in the parking place and that guide driving of the vehicle;
a plurality of parking situation sensing sensors that are installed in each of the plurality of slots and that sense whether vehicles are parked in the plurality of slots or not; and
a service server that manages sensing information sensed from the plurality of vehicle guide sensors and the plurality of parking situation sensing sensors, determines a movement path of the vehicle and a parking slot of the vehicle of the plurality of slots based on the sensing information, and provides the movement path of the vehicle and the parking slot of the vehicle to the vehicle.

2. The system for providing the auto valet parking service of claim 1, wherein
the vehicle guide sensor includes:
a vehicle movement sensing unit that senses movement direction of the vehicle;
a vehicle guide information manager that manages information on the vehicle received from the vehicle and information on the movement direction of the vehicle received from the vehicle movement sensing unit as guide information for guiding movement of the vehicle; and
a data transceiver that provides the guide information to the service server or receives information from the vehicle, the service server, or the parking situation sensing sensor.

3. The system for providing the auto valet parking service of claim 2, further comprising
an alert information generator generating alert information including obstacle sensing information when receiving the obstacle sensing information from the vehicle or the vehicle movement sensing unit and transferring the alert information to any one of the vehicle or the service server.

4. The system for providing the auto valet parking service of claim 1, wherein
the parking situation sensing sensors include:
a vehicle sensing unit that senses whether the vehicle is parked at a corresponding slot or not;
a vehicle sensing information management unit that receives and stores vehicle sensing information that is sensed and generated by the vehicle sensing unit; and
a data transceiver that transfers the vehicle sensing information to the service server according to request for providing the vehicle sensing information from the service server.

5. The system for providing the auto valet parking service of claim 1, wherein
the service server includes:
a communicator that transceives information from/to the vehicle guide sensor and the plurality of parking situation sensing sensors;
a manager that manages information received from the vehicle guide sensor and the plurality of parking situation sensing sensors or manages information determined by the service server; and
a determiner that determines the parking slot of the vehicle of the plurality of slots and determines a path from a current location of the vehicle to the parking slot.

6. The system for providing the auto valet parking service of claim 5, wherein
the vehicle guide sensor transfers alert information including obstacle sensing information to any one of the vehicle or the service server when receiving the obstacle sensing information from the vehicle or the vehicle movement sensing unit, and
the service server further includes a processor that requests the determiner to research the determined path or transmits a driving stop signal to the vehicle when receiving the alert information from the vehicle guide sensor.

7. The system for providing the auto valet parking service of claim 5, wherein
the manager includes:
a parking place data management module that manages information on the parking place at which the vehicle will be parked;
a target vehicle management module that manages information on the vehicle;
a parking history information management module that manages parking history information on the vehicle receiving the auto valet parking service;
a vehicle guide sensor management module that monitors and manages states of the plurality of vehicle guide sensors;
a parking situation sensing sensor management module that monitors and manages states of the plurality of parking situation sensing sensors; and
a vehicle movement situation management module that manages information on current location and information on movement direction of the vehicle.

8. The system for providing the auto valet parking service of claim 5, wherein
the determiner includes:
a parking location determining module that determines the parking slot of the vehicle of the plurality of slots based on the information on the current location received from the vehicle;
a movement path determining module that determines the movement path from the current location of the vehicle to the parking slot determined by the parking location determining module; and
a guide information generating module that generates guide information including the information on the parking slot and the movement path determined in the parking location determining module and the movement path determining module.

9. A control system for controlling a vehicle receiving an auto valet parking service from a system for providing the auto valet parking service, comprising:
a vehicle movement controller that controls movement of a vehicle based on guide information on the vehicle transmitted by the system for providing the auto valet parking service;
an obstacle recognizer that recognizes an obstacle appearing during movement of the vehicle and generates obstacle recognition information; and
a vehicle movement instructor that transfers vehicle parking instruction information to the vehicle movement controller to instruct the movement of the vehicle and transfers the obstacle recognition information to the system for providing the auto valet parking service.

10. The control system of claim 9, wherein
the vehicle movement instructor includes:
a vehicle information manager that manages information on the vehicle;
a server communicator that transceives information informing of start and end of the auto valet parking service from/to the system for providing the auto valet parking service; and
a vehicle guide sensor communicator that receives the vehicle guide information from the system for providing the auto valet parking service and provides the vehicle guide information to the vehicle movement controller.

11. A method for providing an auto valet parking service of a vehicle in a system for providing the auto valet parking service, comprising:
receiving information on a target vehicle to use the service;
determining a parking slot of the target vehicle of a plurality of slots formed in a parking place based on situation information on the parking place;
determining a movement path based on information on current location of the target vehicle and information on the parking slot to transfer the movement path to the target vehicle;
modifying the movement path to generate a modified movement path when an obstacle appears during guiding of the target vehicle according to the movement path; and
guiding the target vehicle through the modified movement path.

12. The method for providing the auto valet parking service of claim 11, wherein,
in a case where an obstacle appears, the method further comprises
determining whether an appearance cause for the obstacle has been solved or not per a preset time period, and
if the appearance cause for the obstacle has not been solved, stopping guiding of the vehicle.

13. A method for controlling a vehicle receiving an auto valet parking service through a system for providing an auto valet parking service, comprising:
requesting the service providing system to provide the service including information on a vehicle;
when receiving guide information that is generated based on the information on the vehicle from the service providing system, initializing a vehicle movement control module and an obstacle recognition sensor;
when receiving information informing of recognition of an obstacle from the vehicle, transferring the obstacle recognition information to the service providing system; and
receiving modified guide information from the service providing system and controlling parking of the vehicle based on the modified guide information.

14. The method of claim 13, wherein
the initializing includes
transferring information on the vehicle that is moved based on the guide information to the service providing system.
